(19) United States
(12) Patent Application Publication
(10) Pub. No.: US 2014/0207502 A1
(43) Pub. Date: Jul. 24, 2014

(54) POWER GENERATION FACILITY INFORMATION MANAGEMENT SYSTEM AND POWER GENERATION FACILITY INFORMATION MANAGEMENT METHOD

(71) Applicant: KABUSHIKI KAISHA TOSHIBA, Minato-ku (JP)

(72) Inventors: Hideki NODA, Saku-shi (JP); Reiko Obara, Kawasaki-shi (JP); Takenori Kobayashi, Tokyo (JP); Kazuhiro Wada, Yokohama-shi (JP)

(73) Assignee: KABUSHIKI KAISHA TOSHIBA, Minato-ku (JP)

(21) Appl. No.: 14/224,473

(22) Filed: Mar. 25, 2014

Related U.S. Application Data
(63) Continuation of application No. PCT/JP2012/074939, filed on Sep. 27, 2012.

(30) Foreign Application Priority Data
Sep. 28, 2011 (JP) 2011-213296

(51) Int. Cl. G06Q 10/06

(52) U.S. Cl. CPC G06Q 10/063
USPC 705/7.11

(57) ABSTRACT

According to one embodiment, there is provided a power generation facility information management system including a power generation variation information analysis unit configured to analyze information about the form of a stop of power generation, and information about the form of a variation in the power generation amount, thereby analyzing the possibility of reduction of an environmental impact caused by the power generation. The system includes a calculation unit configured to calculate the reduction amount of the environmental impact when the stop in an avoidable power generation stop period is assumed to be avoided and calculate the reduction amount of the environmental impact when the avoidable variation is assumed to be avoided, based on the analysis result.

### CROSS-REFERENCE TO RELATED APPLICATIONS

This application is a Continuation application of PCT Application No. PCT/JP2012/074939, filed Sep. 27, 2012 and based upon and claiming the benefit of priority from Japanese Patent Application No. 2011-213296, filed Sep. 28, 2011, the entire contents of all of which are incorporated herein by reference.

### FIELD

Embodiments described herein relate generally to a power generation facility information management system and a power generation facility information management method used in, for example, thermal power generation or geothermal power generation.

### BACKGROUND

Conventionally, various environmental impact factors such as greenhouse gases, SOₓ, and NOₓ are generated at the time of power generation in a power generation facility. A CO₂ emission will be explained below as a representative environmental impact factor. The degree of environmental impact factors is larger than the degree of power conversion losses in power transmission or substations. Power companies are pushing forward with environmental load reduction of power generation facilities. When CO₂ emission rights trading, carbon taxes, and the like are introduced in the future, CO₂ emission management at the time of power generation becomes more important.

The CO₂ emission at the time of power generation is affected by power generation stop in the case of an inspection or a breakdown of a power generation facility. The CO₂ emission at the time of power generation is also affected by a variation in the power generation amount caused by the external environment. For example, the CO₂ emission at the time of geothermal power generation is affected by a variation in the natural steam amount. The CO₂ emission at the time of photovoltaic power generation or wind power generation is affected by variations caused by weather. For these reasons, to make an appropriate CO₂ emission reduction plan, it is necessary to analyze the factors of the power generation stop or output variation in the power generation facilities.

Information about the power generation stop or a variation in the power generation amount of a power generation facility is assumed to be often grasped by the information management system of a power company. However, this system neither aims at reducing the CO₂ emission nor analyzes the factors of the power generation stop or output variation in the power generation facilities, and therefore cannot contribute to making an appropriate CO₂ emission reduction plan.

### BRIEF DESCRIPTION OF DRAWINGS

FIG. 1 is a block diagram showing an example of the functional arrangement of a power generation facility information management system according to the first embodiment.

FIG. 2 is a view showing an example of the execution procedure of the power generation facility information management system according to the first embodiment.

FIG. 3 is a block diagram showing an example of the functional arrangement of the potential calculation unit 120 of the power generation facility information management system according to the first embodiment.

FIG. 4 is a view showing an example of the execution procedure of the power generation variation information analysis unit 110 and the potential calculation unit 120 of the power generation facility information management system according to the first embodiment.

FIG. 5 is a view showing an example of stop information analyzed by the stop information analysis unit 112A of the power generation facility information management system according to the first embodiment and an example of the execution procedure of a stop reason determination unit 112A2.

FIG. 6 is a block diagram showing an example of the functional arrangement of the output variation information analysis unit 112B of the power generation facility information management system according to the first embodiment.

FIG. 7A is a view showing an example of the execution procedure of the output variation information analysis unit 112B of the power generation facility information management system according to the first embodiment.

FIG. 7B is a view showing an example of an output variation graph generated by the output variation information analysis unit 112B of the power generation facility information management system according to the first embodiment.

FIG. 7C is a view showing an example of an output variation graph generated by the output variation information analysis unit 112B of the power generation facility information management system according to the first embodiment.

FIG. 7D is a view showing an example of an output variation graph generated by the output variation information analysis unit 112B of the power generation facility information management system according to the first embodiment.

FIG. 8 is a view showing an example of the functional arrangement and an example of the display contents of the potential display unit 130 of the power generation facility information management system according to the first embodiment.

FIG. 9 is a view showing an example of the execution procedure of an output variation reason determination unit 112B3 according to the second embodiment to calculate an environmental impact in consideration of an increase in the environmental impact caused by a measure that avoids the output variation.

FIG. 10 is a view showing an example of the functional arrangement of an output variation reason determination unit 112B3 according to the third embodiment.

FIG. 11 is a view showing an example of the execution procedure of the output variation reason determination unit 112B3 according to the third embodiment to calculate an environmental impact in consideration of a decrease in the output caused by fuel quality deterioration.

FIG. 12 is a view showing examples of a coal fired power generation output characteristic and coal lot use data used to calculate an environmental impact in consideration of an output decrease caused by fuel quality deterioration.

FIG. 13 is a view showing an example of the execution procedure of an output variation reason determination unit 112B3 according to the fourth embodiment.

FIG. 14 is a view showing an example of the functional arrangement of an output variation information analysis unit 112B according to the fifth embodiment, which is configured to automatically generate information used to evaluate an output variation.

FIG. 15 is a view showing an example of the functional arrangement of a potential display unit 130 according to the sixth embodiment configured to analyze the difference between the planned value and the actual value of environmental impact reduction and an example of a display screen.

FIG. 16 is a view showing an example of the functional arrangement of a difference analysis unit 135 of a potential display unit 130 according to the seventh embodiment configured to display “improvable/unimprovable” of a power generation amount difference generation factor and an example of a display screen.

### DETAILED DESCRIPTION

In general, according to an embodiment, a power generation facility information management system includes a power generation variation information analysis unit configured to analyze information about the form of a stop of power generation of a power generation facility, including a stop reason and a stop period, and information about the form of a variation in the power generation amount, including a reason for the variation, thereby analyzing the possibility of reduction of an environmental impact caused by the power generation. The power generation facility information management system includes a calculation unit configured to calculate the reduction amount of the environmental impact when the stop in an avoidable power generation stop period is assumed to be avoided and calculate the reduction amount of the environmental impact when the avoidable variation is assumed to be avoided, based on the analysis result of the power generation variation information analysis unit.

The embodiments will now be described with reference to the accompanying drawings.

### First Embodiment

The first embodiment will be described.

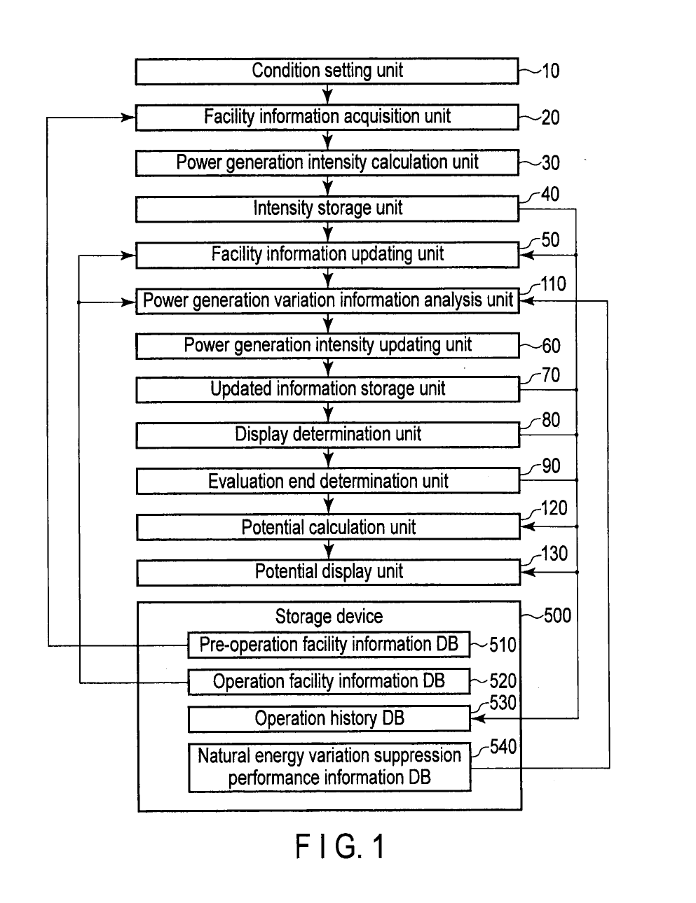

FIG. 1 is a block diagram showing an example of the functional arrangement of a power generation facility information management system according to the first embodiment.

The power generation facility information management system according to this embodiment includes a condition setting unit 10, a facility information acquisition unit 20, a power generation intensity calculation unit 30, an intensity storage unit 40, a facility information updating unit 50, a power generation intensity updating unit 60, an updated information storage unit 70, a display determination unit 80, an evaluation end determination unit 90, a power generation variation information analysis unit 110, a potential calculation unit 120, a potential display unit 130, and a storage device 500.

The storage device 500 is a storage medium such as a nonvolatile memory. The storage device 500 includes a pre-operation facility information DB (database) 510, an operation facility information DB 520, an operation history DB 530, and a natural energy variation suppression performance information DB 540.

The characteristic elements of the power generation facility information management system according to this embodiment, compared to a conventional power generation facility information management system, are the power generation variation information analysis unit 110, the operation facility information DB 520, the operation history DB 530, the natural energy variation suppression performance information DB 540, the potential calculation unit 120, and the potential display unit 130.

The pre-operation facility information DB 510 of the storage device 500 stores facility information. The facility information includes the capacity utilization, station service power, power generation amount, and efficiency of a power generation facility.

The operation facility information DB 520 stores information at the time of operation and power generation variation information 521. The information at the time of operation includes the power generation amount, station service power, fuel consumption, and efficiency. The power generation variation information includes the power generation stop period of the power generation facility, the reason of power generation stop during this period, the output variation period of the power generation amount, and the reason for output variation during this period.

The operation history DB 530 stores a power generation variation information analysis result.

The natural energy variation suppression performance information DB 540 stores threshold information capable of suppressing the output variation of a natural energy power supply. The threshold information includes an allowable output variation rate (%) and an allowable output change width (kWh).

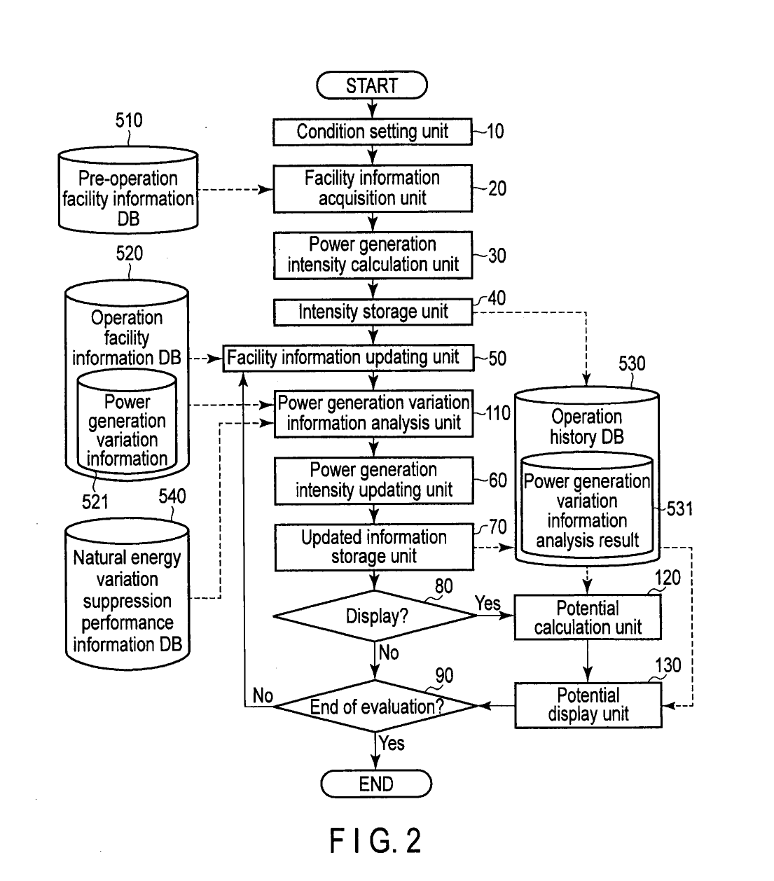

FIG. 2 is a view showing an example of the execution procedure of the power generation facility information management system according to the first embodiment. The display determination unit 80 and the evaluation end determination unit 90 will be described as the process branches of condition determination in FIG. 2.

The condition setting unit 10 sets the target power generation facility, environmental impact factor types (for example, CO₂ emission), period, target power generation facility on the grid side (alternative power generation facility in the case of facility stop), and the like.

The facility information acquisition unit 20 acquires pre-operation facility information such as the capacity utilization, station service power, power generation amount, and efficiency from the pre-operation facility information DB 510.

The power generation intensity calculation unit 30 adds fuel information (for example, heating value) released by the IPCC (Intergovernmental Panel on Climate Change) or the like to the pre-operation facility information obtained from the pre-operation facility information DB 510, thereby calculating the power generation intensity (g-CO₂/kWh). As the calculation method, a known method such as CDM (Clean Development Mechanism) is used.

The intensity storage unit 40 stores the power generation intensity calculated by the power generation intensity calculation unit 30 in the operation history DB 530 of the storage device 500. In addition to the above-described power generation intensity, the operation history DB 530 stores conditions from the intensity storage unit 40, which are used to calculate the power generation intensity. The conditions include the capacity utilization, efficiency, fuel heating value, power generation amount, and station service power acquired from the pre-operation facility information DB 510.

The above-described calculation is based on design information before the start of operation. Subsequent calculation from calculation by the facility information updating unit 50 is done using information after operation.

The facility information updating unit 50 acquires information such as the power generation amount, station service power, fuel consumption, and efficiency necessary for calculation of the power generation intensity from the operation facility information DB 520.

Additionally, in this embodiment, the facility information updating unit 50 acquires the power generation variation information 521 from the operation facility information DB 520. The power generation variation information 521 includes a stop period that affects CO₂ emission calculation, an issue that affects CO₂ emission calculation during this period, the output variation period/variation amount, and the reason for output variation during this period.

The power generation variation information analysis unit 110 acquires threshold information capable of suppressing the output variation of a natural energy power supply from the natural energy variation suppression performance information DB 540. The power generation variation information analysis unit 110 acquires the power generation variation information 521 from the facility information updating unit 50.

The power generation variation information analysis unit 110 analyses the cause of the variation in the power generation amount using the pieces of acquired information and determines whether the variation in the power generation amount is avoidable. The power generation variation information analysis unit 110 stores the analysis result in the operation history DB 530 as a power generation variation information analysis result 531. In addition, the power generation variation information analysis unit 110 sets a period for calculating the power generation intensity. Details of the power generation variation information analysis unit 110 will be described later.

The power generation intensity updating unit 60 calculates the power generation intensity in each period set by the power generation variation information analysis unit 110. The power generation intensity calculation method of the power generation intensity updating unit 60 is the same as that of the power generation intensity calculation unit 30.

The updated information storage unit 70 stores the power generation intensity calculated by the power generation intensity updating unit 60 and information of calculation conditions of the power generation intensity in the operation history DB 530, like the intensity storage unit 40.

If there is no power generation intensity calculation result display request, the display determination unit 80 notifies the evaluation end determination unit 90 of it. If evaluation of the environmental impact reduction potential has not ended yet, the evaluation end determination unit 90 notifies the facility information updating unit 50 of it.

On the other hand, if there is a power generation intensity calculation result display request, that is, upon determining to perform display, the display determination unit 80 notifies the potential calculation unit 120 of such.

Then, the potential calculation unit 120 quantifies the avoidable environmental impact generation amount as an environmental impact reduction potential using the information of the operation history DB 530 including the power generation variation information analysis result 531. In this case, the avoidable environmental impact generation amount is a reducible CO₂ emission. The potential display unit 130 displays the calculation result by the potential calculation unit 120 in a form usable by the power company. Details of the potential calculation unit 120 and the potential display unit 130 will be described later.

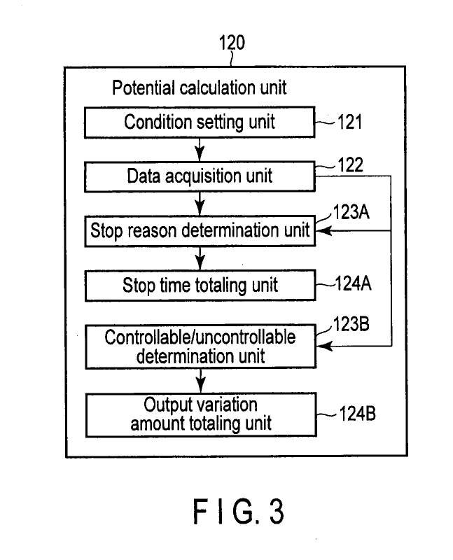

FIG. 3 is a block diagram showing an example of the functional arrangement of the potential calculation unit 120 of the power generation facility information management system according to the first embodiment.

As shown in FIG. 3, the potential calculation unit 120 includes a condition setting unit 121, a data acquisition unit 122, a stop reason determination unit 123A, a controllable/uncontrollable determination unit 123B, a stop time totaling unit 124A, and an output variation amount totaling unit 124B. The functions of these units will be described later.

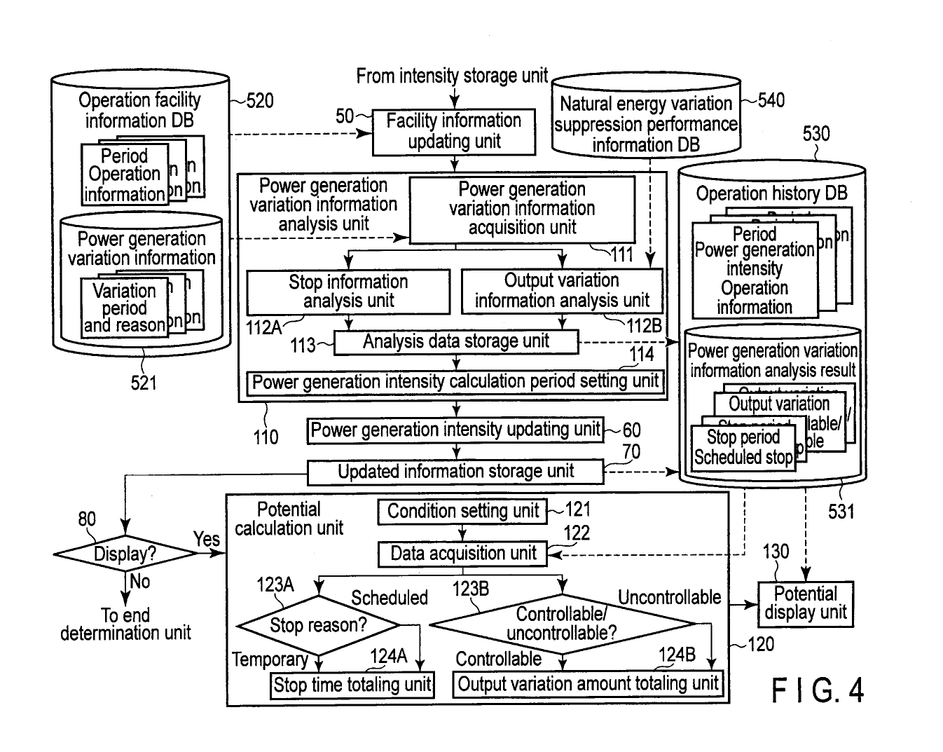

FIG. 4 is a view showing an example of the execution procedure of the power generation variation information analysis unit 110 and the potential calculation unit 120 of the power generation facility information management system according to the first embodiment.

As shown in FIG. 4, the power generation variation information analysis unit 110 includes a power generation variation information acquisition unit 111, a stop information analysis unit 112A, an output variation information analysis unit 112B, an analysis data storage unit 113, and a power generation intensity calculation period setting unit 114.

The stop reason determination unit 123A and the controllable/uncontrollable determination unit 123B of the potential calculation unit 120 will be described as the process branches of condition determination in FIG. 4.

As shown in FIG. 4, the power generation variation information acquisition unit 111 of the power generation variation information analysis unit 110 acquires the power generation variation information 521 from the operation facility information DB 520.

The stop information analysis unit 112A analyzes stop information acquired from the power generation variation information acquisition unit 111. On the other hand, the output variation information analysis unit 112B analyses output variation information acquired from the power generation variation information acquisition unit 111 using threshold information. The threshold information is information acquired from the natural energy variation suppression performance information DB 540 and representing a threshold capable of suppressing the output variation of a natural energy power supply.

The analysis data storage unit 113 obtains analysis results by the stop information analysis unit 112A and the output variation information analysis unit 112B, and stores the analysis results in the operation history DB 530 as the power generation variation information analysis result 531.

The power generation intensity calculation period setting unit 114 sets the divisions of the period for calculating the power generation intensity such that they match the time divisions of the analysis results obtained by the analysis data storage unit 113.

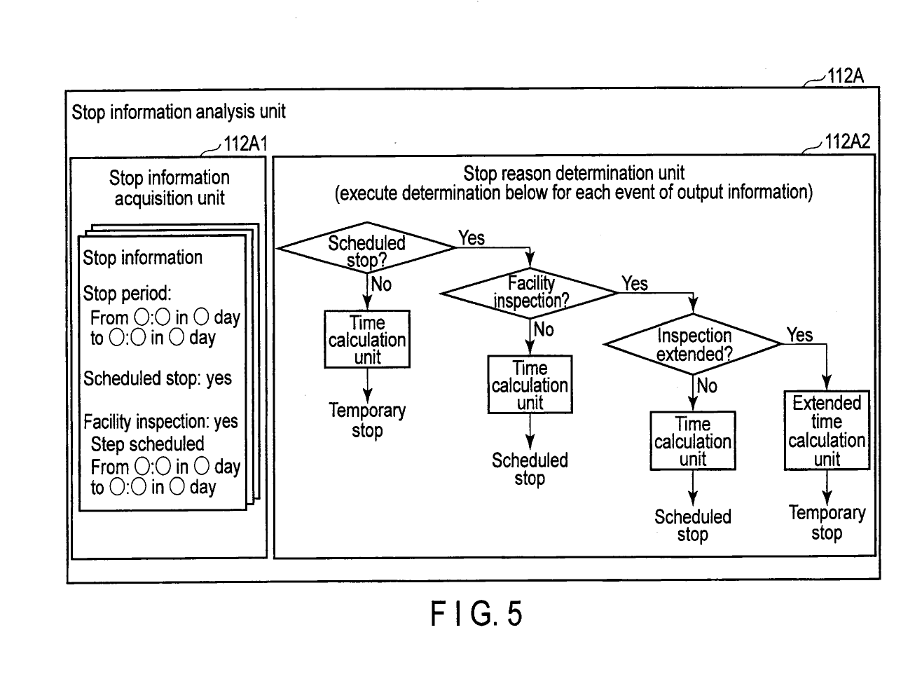

FIG. 5 is a view showing an example of stop information analyzed by the stop information analysis unit 112A of the power generation facility information management system according to the first embodiment and an example of the execution procedure of a stop reason determination unit 112A2. As shown in FIG. 5, the stop information analysis unit 112A of the power generation variation information analysis unit 110 includes a stop information acquisition unit 112A1 and the stop reason determination unit 112A2.

The stop information acquisition unit 112A1 acquires stop information as shown in FIG. 5. The stop information represents whether a stop is a scheduled stop or a stop due to an inspection. In the case of a stop due to an inspection, the stop information represents how long the scheduled stop time is.

The stop reason determination unit 112A2 determines for each event of output information whether the stop indicated by the stop information is a scheduled stop. If the stop indicated by the stop information is not a scheduled stop, the stop reason determination unit 112A2 calculates the cumulative stop time, and determines that the stop indicated by the stop information is a stop that has temporarily occurred.

If the stop indicated by the stop information is a scheduled stop, the stop reason determination unit 112A2 determines whether the stop is a stop due to a facility inspection. If the stop indicated by the stop information is not a stop due to a facility inspection, the stop reason determination unit 112A2 calculates the cumulative stop time, and determines that the stop indicated by the stop information is a scheduled stop.

If the stop indicated by the stop information is a stop due to a facility inspection, the stop reason determination unit 112A2 determines whether the inspection is extended. If the inspection is not extended, the stop reason determination unit 112A2 calculates the cumulative time, and determines that the stop indicated by the stop information is a scheduled stop.

If the inspection is extended, the stop reason determination unit 112A2 calculates the extension time, and determines that the stop indicated by the stop information is a stop that has temporarily occurred.

If the stop indicated by the stop information is a stop that has temporarily occurred, the stop reason determination unit 112A2 determines that the stop should be avoidable because the stop assumes an additional repair revealed to be necessary at the time of breakdown or inspection.

In the above-described way, the stop information analysis unit 112A of the power generation variation information analysis unit 110 analyzes the stop information of power generation of the power generation facility, thereby analyzing whether a stop of power generation is avoidable. This makes it possible to analyze the possibility of environmental impact reduction in power generation.

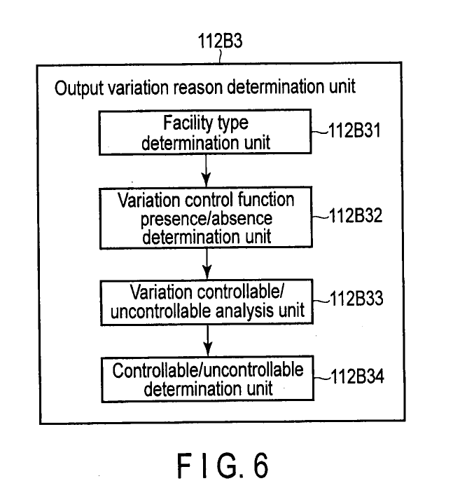

FIG. 6 is a block diagram showing an example of the functional arrangement of the output variation information analysis unit 112B of the power generation facility information management system according to the first embodiment.

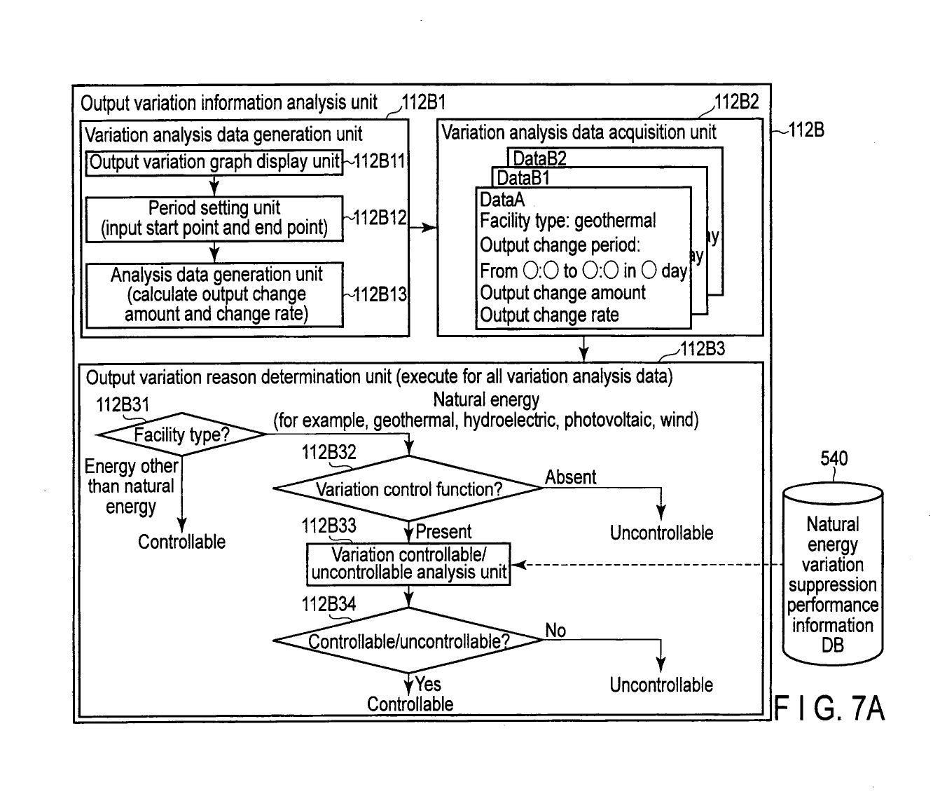

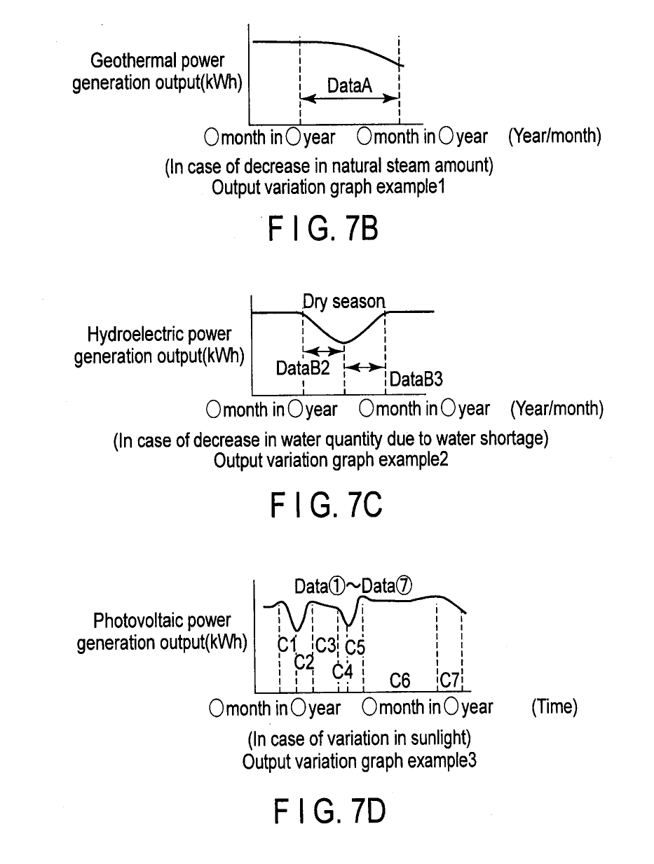

FIG. 7A is a view showing an example of the execution procedure of the output variation information analysis unit 112B of the power generation facility information management system according to the first embodiment.

As shown in FIG. 7A, the output variation information analysis unit 112B of the power generation variation information analysis unit 110 includes a variation analysis data generation unit 112B1, a variation analysis data acquisition unit 112B2, and an output variation reason determination unit 112B3.

The variation analysis data generation unit 112B1 includes an output variation graph display unit 112B11, a period setting unit 112B12, and an analysis data generation unit 112B13.

As shown in FIG. 6, the output variation reason determination unit 112B3 includes a facility type determination unit 112B31, a variation control function presence/absence determination unit 112B32, a variation controllable/uncontrollable analysis unit 112B33, and a controllable/uncontrollable determination unit 112B34.

The output variation graph display unit 112B11 in the variation analysis data generation unit 112B1 creates an output variation graph based on the power generation variation information 521 acquired by the power generation variation information acquisition unit 111 and displays it. FIGS. 7B, 7C, and 7D show examples of the output variation graph as output variation graph examples 1, 2, and 3.

Next, the period setting unit 112B12 sets the evaluation start point and end point used to perform variation analysis in accordance with an operation on an input device (not shown) by an evaluator who has referred to the graph. The range or step from the evaluation start point to the end point varies from a year/month to an hour/minute depending on the characteristics of the power generation method, as shown in the output variation graph examples.

For example, as shown in FIG. 7B, the power generation output by geothermal power generation gradually varies due to a yearly/monthly variation in the natural steam amount. For this reason, each of the step of the time base of the output variation graph and the period set by the period setting unit 112B12 is a year/month.

As shown in FIG. 7C, the power generation output by hydroelectric power generation varies due to a monthly/daily water shortage or the like. For this reason, each of the step of the time base of the output variation graph and the period set by the period setting unit 112B12 is a month/day.

As shown in FIG. 7D, the power generation output by photovoltaic power generation varies hourly depending on the sunlight irradiation state. For this reason, each of the step of the time base of the output variation graph and the period set by the period setting unit 112B12 is an hour.

The analysis data generation unit 112B13 calculates the output change amount (kWh) and the change rate (%) of generated power during the period set by the period setting unit 112B12. This makes it possible to generate a plurality of kinds of variation analysis data, as shown in FIGS. 7B, 7C, and 7D.

The variation analysis data acquisition unit 112B2 acquires these variation analysis data. The output variation reason determination unit 112B3 determines, for each of the acquired variation analysis data, whether the output variation represented by the variation analysis data is a controllable output variation.

A detailed example of determination of the output variation reason determination unit 112B3 will be described. The facility type determination unit 112B31 of the output variation reason determination unit 112B3 determines whether the power generation facility type is natural energy or energy other than natural energy. The power generation facility type indicates the power generation source. Natural energy includes geothermal energy, hydroelectric energy, photovoltaic energy, and wind energy.

When the power generation source is not natural energy, the facility type determination unit 112B31 determines that the output variation is controllable. When the power generation source is natural energy, the variation control function presence/absence determination unit 112B32 determines whether the power generation facility has a function of suppressing the variation in the power generation amount caused by the natural energy. If the power generation source is natural energy, and the power generation facility has no function of suppressing the variation in the power generation amount caused by the natural energy, the variation control function presence/absence determination unit 112B32 determines that the output variation is uncontrollable.

On the other hand, if the variation control function presence/absence determination unit 112B32 determines that the power generation facility has the above-described variation suppression function, the variation controllable/uncontrollable analysis unit 112B33 acquires information such as the allowable output variation rate (%) and the allowable output change width (kWh) of the natural energy power supply from the natural energy variation suppression performance information DB 540, and compares the variation widths or variation rates. The controllable/uncontrollable determination unit 112B34 determines whether the variation falls within a controllable range. If the operation data falls within the control tolerance, the controllable/uncontrollable determination unit 112B34 determines that the variation is controllable and should be avoidable. In the above-described way, the output variation information analysis unit 112B of the power generation variation information analysis unit 110 analyzes the power generation amount variation information, thereby analyzing whether the variation is avoidable. This makes it possible to analyze the possibility of environmental impact reduction in power generation.

The execution procedure of the potential calculation unit 120 will be described next with reference to FIG. 4.

The condition setting unit 121 shown in FIG. 3 sets the time range when causing the potential display unit 130 to display the environmental impact reduction potential. The data acquisition unit 122 acquires data corresponding to the set time range from the operation history DB 530.

The stop reason determination unit 123A classifies information about operation stops into scheduled stops and temporary stops. The stop time totaling unit 124A totals the stop times for each classification by the stop reason determination unit 123A. The stop time totaling unit 124A outputs the totaling results to the potential display unit 130 as a total scheduled stop time and a total temporary stop time.

On the other hand, the controllable/uncontrollable determination unit 123B classifies information about output variations into variation controllable and uncontrollable. The output variation amount totaling unit 124B totals the output variation amounts for each classification. The output variation amount totaling unit 124B outputs the totaling results to the potential display unit 130 as a total controllable output variation value and a total uncontrollable output variation value.

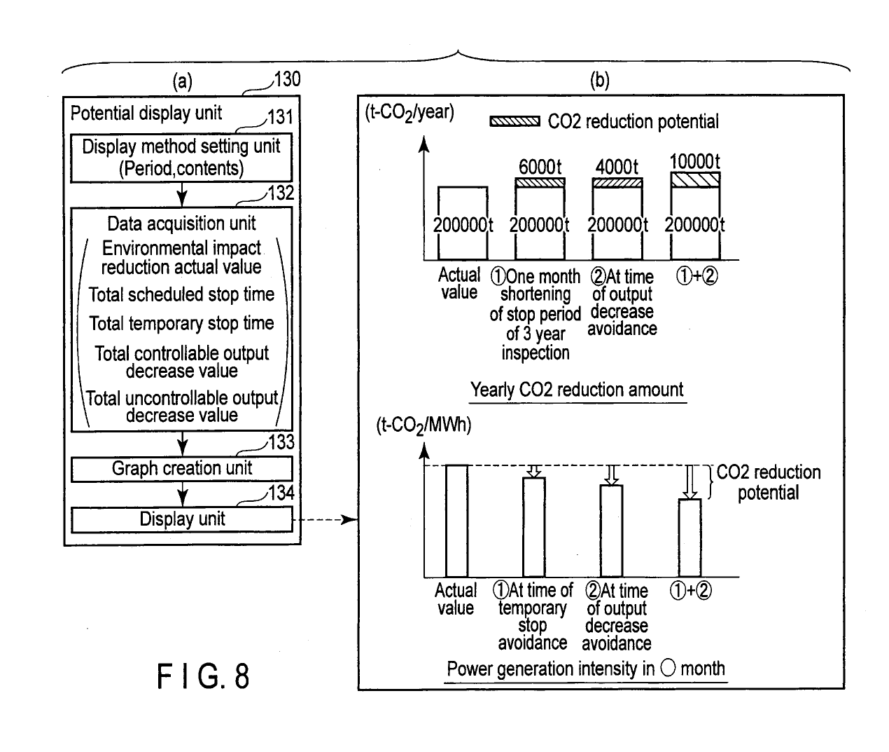

FIG. 8 is a view showing an example of the functional arrangement and an example of the display contents of the potential display unit 130 of the power generation facility information management system according to the first embodiment.

As shown in (a) of FIG. 8, the potential display unit 130 includes a display method setting unit 131, a data acquisition unit 132, a graph creation unit 133, and a display unit 134. The display unit 134 is a liquid crystal display device or the like.

The display method setting unit 131 of the potential display unit 130 sets the display period or the display method (sets the ordinate and abscissa). As indicated by the display example of (b) of FIG. 8, the ordinate plots a yearly CO₂ emission (t-CO₂/year), a power generation intensity (t-CO₂/MWh), or the like.

The data acquisition unit 132 acquires the information of the actual environmental impact reduction value from the operation history DB 530. In this case, the actual environmental impact reduction value is the actual value of the yearly CO₂ reduction amount or monthly power generation intensity. The data acquisition unit 132 also obtains the output information of the potential calculation unit 120. The output information includes the total scheduled stop time, the total temporary stop time, the total controllable output variation value, and the total uncontrollable output variation value.

The graph creation unit 133 creates first to fourth histograms of the yearly CO₂ reduction amount, as shown on the upper side of (b) of FIG. 8, using the acquired information, and displays them on the display unit 134.

The first histogram indicates the actual value of the yearly CO₂ reduction amount. The second histogram indicates the yearly CO₂ reduction amount when the stop period of a 3-year inspection is assumed to be shortened by one month. The stop period of the 3-year inspection is the stop period of an inspection performed every three years.

The third histogram indicates the yearly CO₂ reduction amount when an output decrease is assumed to be avoided. The fourth histogram indicates the yearly CO₂ reduction amount when both the above-described one-month shortening of the stop period of the 3-year inspection and the output decrease avoidance are assumed.

The difference between the yearly CO₂ reduction amount at the time of one-month shortening of the stop period of the 3-year inspection indicated by the second histogram and the actual value of the yearly CO₂ reduction amount indicated by the first histogram out of the characteristic amounts indicated by the histograms shown on the upper side of (b) of FIG. 8 is the CO₂ reduction potential resulting from the one-month shortening of the stop period of the 3-year inspection.

The difference between the actual value of the yearly CO₂ reduction amount indicated by the first histogram and the yearly CO₂ reduction amount at the time of output decrease avoidance indicated by the third histogram shown on the upper side of (b) of FIG. 8 is the CO₂ reduction potential resulting from the output decrease avoidance.

The difference between the actual value of the yearly CO₂ reduction amount indicated by the first histogram and the yearly CO₂ reduction amount indicated by the histogram of the yearly CO₂ reduction amount at the time of one-month shortening of the stop period of the 3-year inspection and the output decrease avoidance, which is indicated by the fourth histogram shown on the upper side of (b) of FIG. 8, is the CO₂ reduction potential resulting from one-month shortening of the stop period of the 3-year inspection and the output decrease avoidance.

The graph creation unit 133 creates first to fourth histograms of the power generation intensity, as shown on the lower side of (b) of FIG. 8, using the information acquired from the operation history DB 530. The first histogram of the power generation intensity indicates the actual value of the power generation intensity of a predetermined month. The second histogram of the power generation intensity indicates the power generation intensity at the time of temporary stop avoidance. The third histogram of the power generation intensity indicates the power generation intensity at the time of output decrease avoidance. The fourth histogram of the power generation intensity indicates the power generation intensity at the time of temporary stop avoidance and output decrease avoidance. The graph creation unit 133 displays these histograms on the display unit 134.

The difference between the actual value of the power generation intensity indicated by the first histogram of the power generation intensity and the power generation intensity at the time of temporary stop avoidance indicated by the second histogram of the power generation intensity shown on the lower side of (b) of FIG. 8 is the CO₂ reduction potential resulting from the temporary stop avoidance.

The difference between the actual value of the power generation intensity indicated by the first histogram of the power generation intensity and the power generation intensity at the time of output decrease avoidance indicated by the third histogram of the power generation intensity shown on the lower side of (b) of FIG. 8 is the CO₂ reduction potential resulting from the output decrease avoidance.

The difference between the actual value of the power generation intensity indicated by the first histogram of the power generation intensity and the power generation intensity at the time of temporary stop avoidance and output decrease avoidance indicated by the fourth histogram of the power generation intensity shown on the lower side of (b) of FIG. 8 is the CO₂ reduction potential resulting from the temporary stop avoidance and the output decrease avoidance.

As described above, the power generation facility information management system according to the first embodiment analyzes the reason for a power generation stop or output variation of the power generation facility, calculates the avoidable stop period and output variation amount, and displays environmental impact reduction information when avoiding the stop period or the output variation as an environmental impact reduction potential. By performing such display, the power generation facility information management system can quantitatively present the possibility of environmental impact improvement to the power company. It is therefore possible to contribute to making an appropriate plan to reduce environmental impacts, such as a CO₂ emission from the power generation facility.

### Second Embodiment

The second embodiment will be described next. Note that regarding the power generation facility information management systems according to the following embodiments, a description of the same parts as those shown in FIG. 1 will be omitted.

In this embodiment, the power generation facility information management system is characterized in that it calculates the environmental impact reduction potential in consideration of environmental impacts at the time of output variation control when the output variation of a power generation facility is controllable.

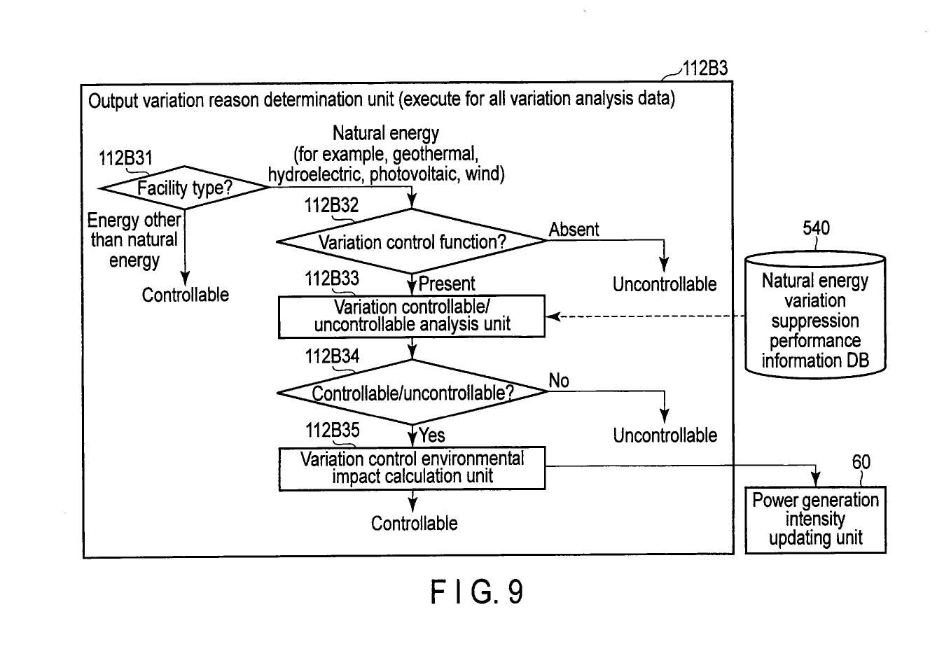

FIG. 9 is a view showing an example of the execution procedure of an output variation reason determination unit 112B3 according to the second embodiment to calculate an environmental impact in consideration of an increase in the environmental impact caused by a measure that avoids the output variation.

As shown in FIG. 9, in this embodiment, the output variation reason determination unit 112B3 further includes a variation control environmental impact calculation unit 112B35, as compared to the first embodiment (see FIG. 7A).

As described in the first embodiment, when a controllable/uncontrollable determination unit 112B34 of the output variation reason determination unit 112B3 determines that a variation in the power generation amount is controllable when the power generation source is natural energy, the variation control environmental impact calculation unit 112B35 calculates a predetermined environmental impact using life cycle assessment or CDM.

The first example of the predetermined environmental impact is an environmental impact caused by manufacturing a power generation output variation control facility prepared in advance. Examples of the power generation output variation control facility are a secondary battery, a water quantity maintaining pump, and a natural steam amount adjustment facility. The second example of the predetermined environmental impact is an environmental impact concerning an energy or resource consumed when operating the facility.

The variation control environmental impact calculation unit 112B35 outputs the environmental impact calculation result to a power generation intensity updating unit 60.

The power generation intensity updating unit 60 can thus calculate the power generation intensity in consideration of the increase in the environmental impact caused by the measure that avoids the output variation. Hence, a potential calculation unit 120 can calculate the environmental impact reduction potential in consideration of the increase in the environmental impact caused by the measure that avoids the output variation. The power generation intensity updating unit 60, for example, proportionally divides the environmental impacts at the manufacturing stage based on the ratio of the facility life and the evaluation period, instead of including all the environmental impacts. The contents of the environmental impact calculation method are known, and a detailed description thereof will be omitted here.

As described above, in the second embodiment, the power generation facility information management system calculates and displays the environmental impact reduction potential in consideration of the environmental impact that is increased by the material or energy necessary to control the output variation of natural energy. Hence, the accuracy of calculation of the environmental impact reduction potential rises, as compared to the first embodiment.

### Third Embodiment

The third embodiment will be described next. A power generation facility information management system according to this embodiment is characterized by determining whether an environmental impact that increases due to fuel quality deterioration is controllable in a power generation facility other than those using natural energy.

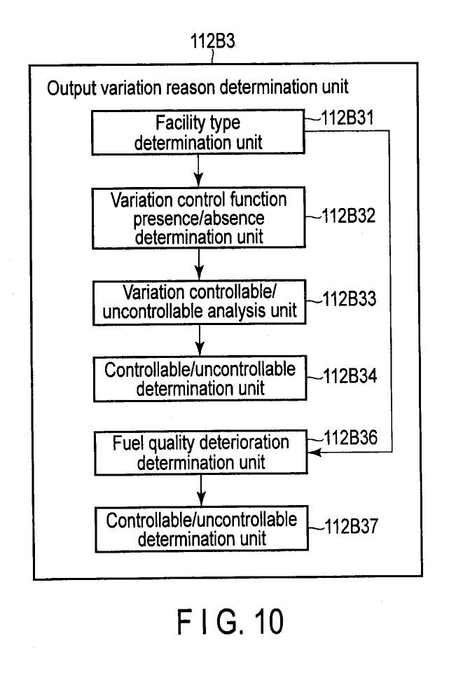

FIG. 10 is a view showing an example of the functional arrangement of an output variation reason determination unit 112B3 according to the third embodiment.

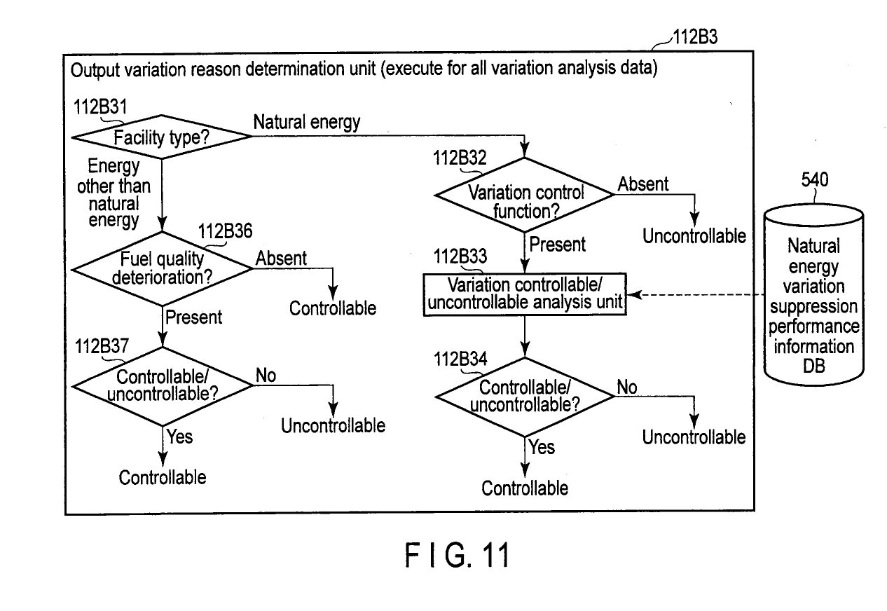

FIG. 11 is a view showing an example of the execution procedure of the output variation reason determination unit 112B3 according to the third embodiment to calculate an environmental impact in consideration of a decrease in the output caused by fuel quality deterioration.

As shown in FIG. 10, in this embodiment, the output variation reason determination unit 112B3 further includes a fuel quality deterioration determination unit 112B36 and a controllable/uncontrollable determination unit 112B37, as compared to the first embodiment (see FIG. 6).

When a facility type determination unit 112B31 determines that the power generation source of the evaluation target power generation facility uses an energy other than natural energy, the fuel quality deterioration determination unit 112B36 determines whether the output variation is caused by deterioration of fuel quality. Examples of the output variation caused by deterioration of fuel quality are an output decrease caused by deterioration of coal quality and an output decrease caused by an impurity in natural steam.

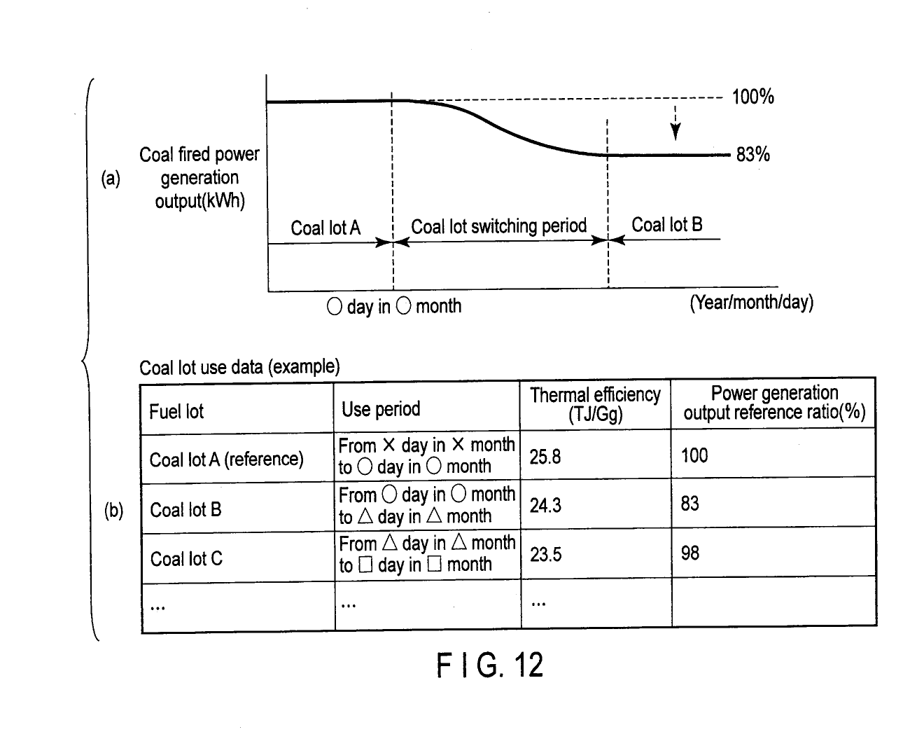

A method of determining the presence/absence of deterioration of fuel quality will be described next. FIG. 12 shows examples of a coal fired power generation output characteristic and coal lot use data used to calculate an environmental impact in consideration of an output decrease caused by fuel quality deterioration.

As shown in (b) of FIG. 12, the data of a use period and thermal efficiency (TJ/Gg) for each fuel type/lot used in the power generation facility are stored in the internal memory of the fuel quality deterioration determination unit 112B36 or a storage device 500. Additionally, as shown in (b) of FIG. 12, the data of a power generation output reference ratio (%) that is the thermal-efficiency ratio from a reference fuel that is, for example, coal is stored in the internal memory of the fuel quality deterioration determination unit 112B36 or the storage device 500.

The fuel quality deterioration determination unit 112B36 compares the degree of decrease in the power generation output during the power generation output decrease period with the use period and the value of the power generation output reference ratio in fuel use data as shown in (b) of FIG. 12.

The power generation output decrease period is the period between the time at which the power generation output decrease has started and the time at which the power generation output decrease has settled at the time of power generation output decrease. In the example shown in (a) of FIG. 12, the time at which the power generation output decrease has started is O day in O month which is the start point of the coal lot switching period. In this case, the time at which the power generation output decrease has settled is the point between the end of the coal lot switching period and the subsequent coal use period. The degree of decrease in the power generation output is 83% in the example shown in FIG. 12.

When the combination of the power generation output decrease period and the degree of decrease in the power generation output almost matches the combination of the use period and the value of the power generation output reference ratio in the fuel use data, the fuel quality deterioration determination unit 112B36 determines that the decrease in the power generation output is caused by quality deterioration of the fuel. The fuel quality deterioration is, for example, quality deterioration caused when the coal lot to be used is switched from coal lot A to coal lot B, as shown in (b) of FIG. 12.

When the fuel quality deterioration determination unit 112B36 determines that the output variation is caused by fuel quality deterioration, the controllable/uncontrollable determination unit 112B37 determines whether the fuel quality deterioration can be prevented. Determining the presence/absence of fuel quality deterioration or whether the quality deterioration can be prevented is generally performed independently of the operation management system. For this reason, the determination by the fuel quality deterioration determination unit 112B36 and the controllable/uncontrollable determination unit 112B37 may be done by the operator while observing a selection screen displayed on the system.

As described above, in the third embodiment, the controllable/uncontrollable determination unit 112B37 determines whether an environmental impact that increases due to fuel quality deterioration is controllable in a power generation facility other than those using natural energy. Hence, a potential calculation unit 120 can calculate the environmental impact reduction potential in consideration of the environmental impact. Hence, the accuracy of calculation of the environmental impact reduction potential rises, as compared to the first embodiment.

### Fourth Embodiment

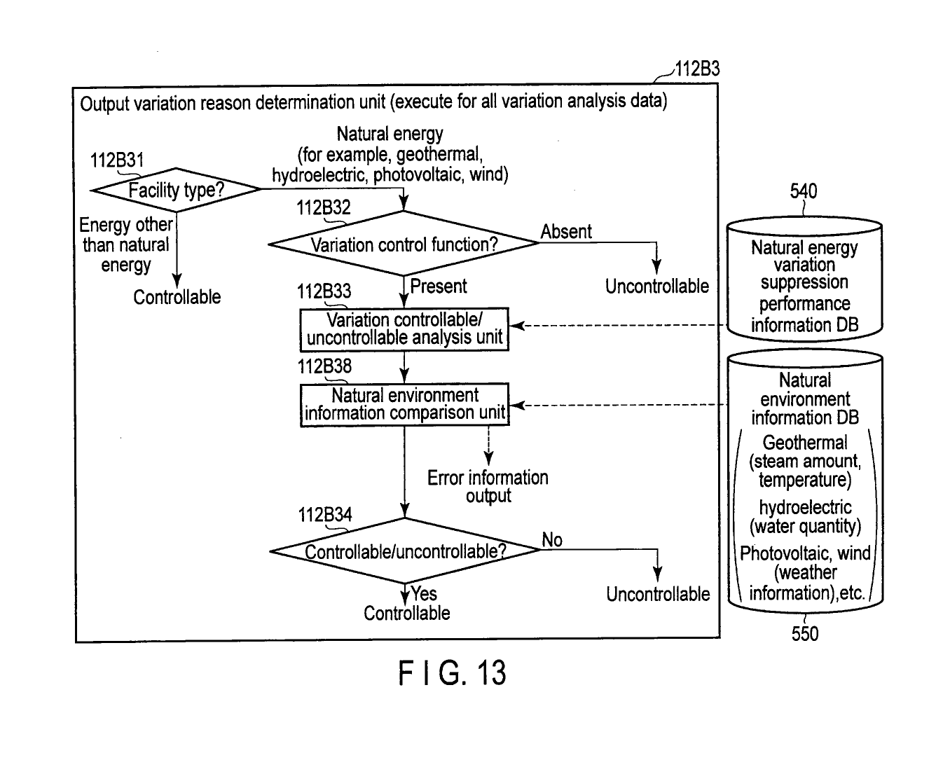

The fourth embodiment will be described next. FIG. 13 is a view showing an example of the execution procedure of an output variation reason determination unit 112B3 according to the fourth embodiment.

In this embodiment, a storage device 500 further includes a natural environment information DB 550, as compared to the first embodiment. In this embodiment, the output variation reason determination unit 112B3 further includes a natural environment information comparison unit 112B38 configured to perform processing after a variation controllable/uncontrollable analysis unit 112B33, as compared to the first embodiment (see FIG. 7A).

The natural environment information DB 550 stores variation information representing the variation amount of natural energy itself when the power generation source is natural energy. When the power generation facility is a geothermal power generation facility, the variation information represents a variation in the steam amount or temperature. When the power generation facility is a hydraulic power generation facility, the variation information represents a variation in the water quantity. When the power generation facility is a photovoltaic/wind power generation facility, the variation information represents a variation in the solar irradiation or air flow.

The natural environment information comparison unit 112B38 performs reexamination of the comparison result of the variation width or variation rate upon acquiring an analysis result from the variation controllable/uncontrollable analysis unit 112B33. The analysis result is information of the allowable output variation rate (%) or allowable output change width (kWh) of the natural energy power supply from a natural energy variation suppression performance information DB 540.

That is, the natural environment information comparison unit 112B38 compares the analysis result from the variation controllable/uncontrollable analysis unit 112B33 with the information (variation amount (kWh) and variation rate (%)) about the output variation, which is stored in the natural environment information DB 550. By performing this comparison, the natural environment information comparison unit 112B38 determines whether the variation in the power generation amount due to the natural energy is caused by a natural phenomenon itself. Upon determining that the variation in the power generation amount due to the natural energy is irrelevant to the natural phenomenon, the natural environment information comparison unit 112B38 determines that an error may have occurred in the analysis result of the variation controllable/uncontrollable analysis unit 112B33. The natural environment information comparison unit 112B38 then presents information representing the error.

As described above, in the fourth embodiment, the power generation facility information management system determines an error in the analysis result of the variation controllable/uncontrollable analysis unit 112B33 using information about the natural environment such as a variation in the natural steam amount or weather. It is therefore possible to raise the accuracy of power generation amount variation controllable/uncontrollable determination.

### Fifth Embodiment

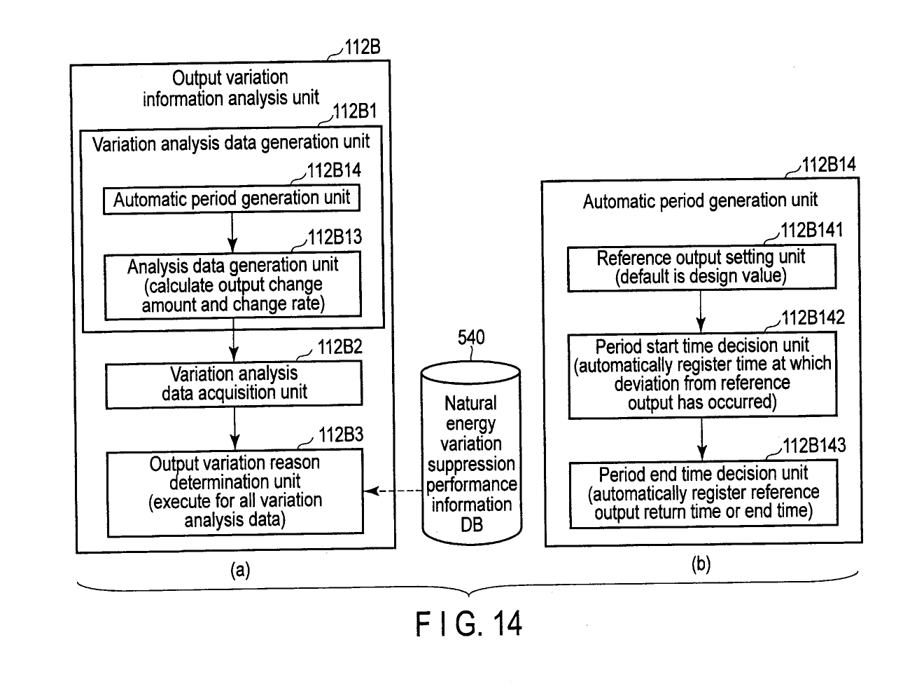

The fifth embodiment will be described next. FIG. 14 is a view showing an example of the functional arrangement of an output variation information analysis unit 112B according to the fifth embodiment, which is configured to automatically generate information used to evaluate an output variation.

As shown in (a) of FIG. 14, in this embodiment, a variation analysis data generation unit 112B1 of the output variation information analysis unit 112B includes an automatic period generation unit 112B14 in place of the output variation graph display unit 112B11 and the period setting unit 112B12 shown in FIG. 7A, as compared to the first embodiment.

Additionally, as shown in (b) of FIG. 14, the automatic period generation unit 112B14 includes a reference output setting unit 112B141, a period start time decision unit 112B142, and a period end time decision unit 112B143.

The reference output setting unit 112B141 of the automatic period generation unit 112B14 sets an output value to be used as the reference of the output variation in accordance with an input operation from the evaluator. The default value of the set value is the output value when calculating the CO₂ emission at the time of design.

The period start time decision unit 112B142 automatically registers time information of a point at which the power generation amount has deviated from the reference output.

The period end time decision unit 112B143 automatically registers a time at which the power generation amount has returned to the above-described reference output or reached an end time.

As described above, in the fifth embodiment, the power generation facility information management system can automatically generate the evaluation period of variation analysis data used to evaluate the output variation. Hence, an analysis data generation unit 112B13 can generate variation analysis data without the necessity of causing the output variation graph display unit 112B11 in the variation analysis data generation unit 112B1 to create an output variation graph or causing the period setting unit 112B12 to set the evaluation start point and end point used to perform variation analysis in accordance with an operation by the evaluator, as described in the first embodiment.

### Sixth Embodiment

The sixth embodiment will be described next.

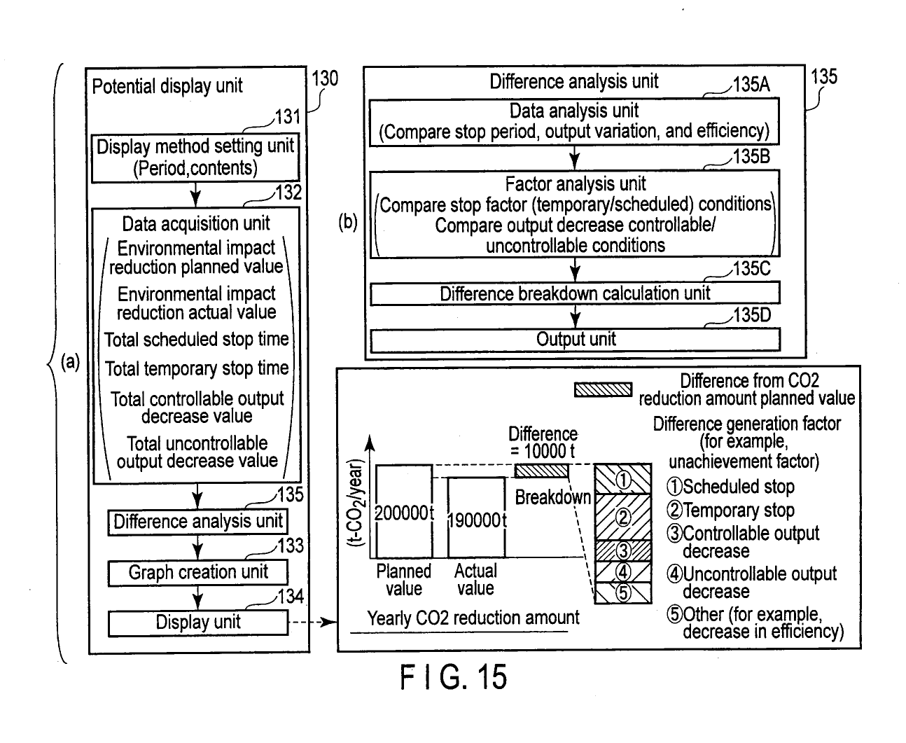

FIG. 15 is a view showing an example of the functional arrangement of a potential display unit 130 according to the sixth embodiment configured to analyze the difference between the planned value and the actual value of environmental impact reduction and an example of a display screen.

As shown in (a) of FIG. 15, in this embodiment, an environmental impact reduction planned value is added to information acquired by a data acquisition unit 132 of the potential display unit 130, as compared to the first embodiment (see (a) of FIG. 8).

Additionally, the potential display unit 130 further includes a difference analysis unit 135, as compared to the first embodiment (see (a) of FIG. 8). The difference analysis unit 135 includes a data analysis unit 135A, a factor analysis unit 135B, a difference breakdown calculation unit 135C, and an output unit 135D, as shown in (b) of FIG. 15.

The data acquisition unit 132 of the potential display unit 130 acquires the stop period, output variation, and efficiency from an operation facility information DB 520. The data analysis unit 135A of the difference analysis unit 135 compares the stop period, output variation, and efficiency acquired by the data acquisition unit 132. The factor analysis unit 135B performs comparison of stop factor (temporary stop/scheduled stop) conditions and comparison of output decrease controllable/uncontrollable conditions.

The difference breakdown calculation unit 135C obtains the breakdown of factors that generate the difference between the planned value and the actual value of a yearly CO₂ reduction amount. Examples of the difference generation factors are scheduled stop, temporary stop, controllable output decrease, uncontrollable output decrease, and other (for example, decrease in efficiency). The output unit 135D displays histograms representing the planned value and the actual value of the yearly CO₂ reduction amount, as shown in (a) of FIG. 15. The output unit 135D also divisionally displays the breakdown of the factors that generate the difference between the planned value and the actual value of the yearly CO₂ reduction amount (for example, a factor that hinders the actual value from reaching the planned value) represented by the histograms, as described above.

As described above, in the sixth embodiment, the power generation facility information management system can compare and analyze the environmental impact reduction planned value set at the stage of facility design and the actual value and divisionally display the difference generation factors. It is therefore possible to more effectively display the environmental impact reduction potential.

### Seventh Embodiment

The seventh embodiment will be described next.

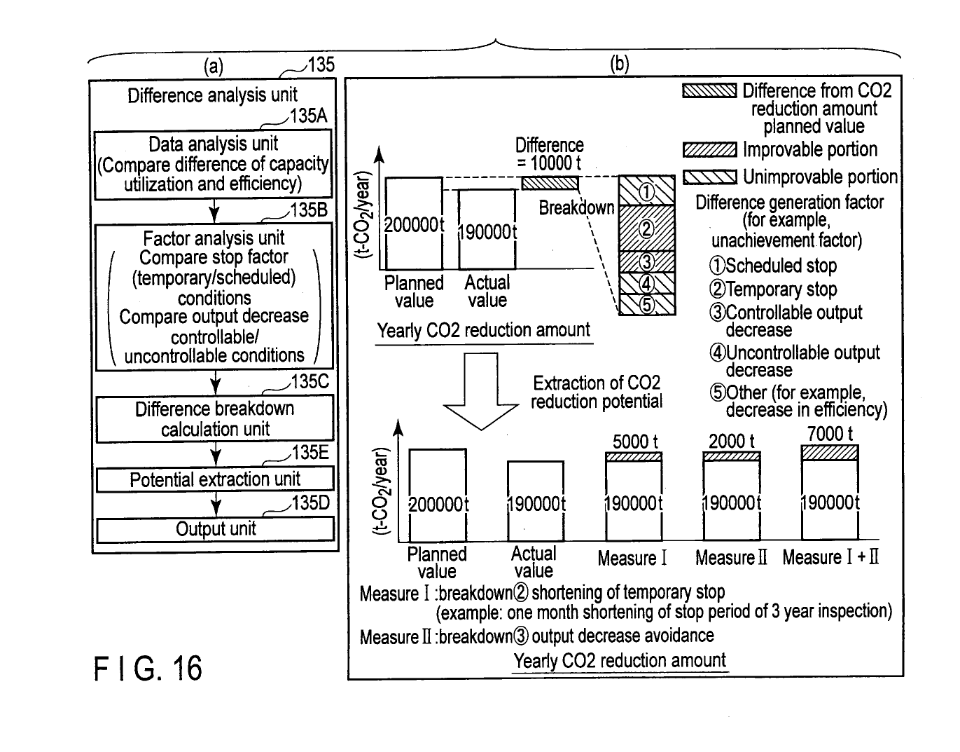

FIG. 16 is a view showing an example of the functional arrangement of a difference analysis unit 135 of a potential display unit 130 according to the seventh embodiment configured to display “improvable/unimprovable” of a power generation amount difference generation factor and an example of a display screen.

As shown in (a) of FIG. 16, in this embodiment, the difference analysis unit 135 further includes a potential extraction unit 135E configured to perform processing after processing of a difference breakdown calculation unit 135C, as compared to the sixth embodiment.

The potential extraction unit 135E extracts improvable portions, that is, portions having a potential from the breakdown of the difference generation factors obtained by the difference breakdown calculation unit 135C, thereby dividing the difference generation factors into improvable portions and unimprovable portions. The potential extraction unit 135E can automatically extract the improvable portions from the difference generation factors by, for example, defining “out of scheduled stop, temporary stop, controllable output decrease, uncontrollable output decrease, and other (for example, decrease in efficiency), temporary stop and controllable output decrease can be avoided” in advance. By performing this extraction, an output unit 135D can divisionally display the improvable portions and unimprovable portions of the difference generation factors, as shown in (b) of FIG. 15, and also display the graphs of the yearly CO₂ reduction amount after taking measures for the improvable portions, as shown in (b) of FIG. 16. In the example shown in (b) of FIG. 16, the improvable portions of the difference generation factors are temporary stop and controllable output decrease.

In the example shown in (b) of FIG. 16, the potential display unit 130 displays the yearly CO₂ reduction amount when temporary stop shortening (for example, one-month shortening of the stop period of the 3-year inspection) is performed. In the example shown in (b) of FIG. 16, the potential display unit 130 also displays the yearly CO₂ reduction amount when controllable output decrease avoidance is performed. In the example shown in (b) of FIG. 16, the potential display unit 130 also displays the yearly CO₂ reduction amount when temporary stop shortening (for example, one-month shortening of the stop period of the 3-year inspection) and controllable output decrease avoidance are performed.

As described above, in the seventh embodiment, the power generation facility information management system can easily discriminate the improvable/unimprovable portions of the factors that generate the difference between the planned value and the actual value of environmental impact reduction. The power generation facility information management system can display the graphs of the environmental impact reduction potential after taking measures for the improvable portions.

According to these embodiments, it is possible to provide a power generation facility information management system and a power generation facility information management method which can contribute to making an appropriate plan to reduce environmental impacts from a power generation facility.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power generation facility information management system comprising:
a power generation variation information analysis unit configured to analyze information about a form of a stop of power generation by a power generation facility, including a stop reason and a stop period of the power generation by the power generation facility, and information about a form of a variation in a power generation amount, including a reason for the variation in the power generation amount, thereby analyzing a possibility of reduction of an environmental impact caused by the power generation; and
a calculation unit configured to calculate a reduction amount of the environmental impact when the stop in an avoidable power generation stop period is assumed to be avoided and calculate the reduction amount of the environmental impact when the avoidable variation is assumed to be avoided, based on an analysis result by the power generation variation information analysis unit.

2. The power generation facility information management system according to claim 1, wherein the calculation unit calculates the reduction amount of the environmental impact in consideration of the environmental impact that increases due to control of a variation amount of the power generation amount by natural energy.

3. The power generation facility information management system according to claim 1, wherein when the reason for the variation in the power generation amount is an energy other than natural energy, the power generation variation information analysis unit analyzes whether the reason for the variation is deterioration of a quality of a fuel, and if the reason of the variation is the deterioration of the quality of the fuel, analyses whether the deterioration of the quality is avoidable, thereby analyzing whether the variation in the power generation amount is controllable to reduce the environmental impact caused by the power generation.

4. The power generation facility information management system according to claim 1, wherein the power generation variation information analysis unit
comprises a determination unit configured to determine whether the power generation facility is a power generation facility using a power generation source other than natural energy, and the power generation facility has a function of controlling the variation in the power generation amount, and
when the determination unit determines that the power generation facility has the function of controlling the variation in the power generation amount, acquires variation information of the natural energy itself and compares the acquired variation information with the information about the form of the variation in the power generation amount, thereby determining whether the variation is caused by the natural energy itself, and upon determining that the variation is not caused by the natural energy itself, outputs error information of the determination by the determination unit.

5. The power generation facility information management system according to claim 1, wherein the power generation variation information analysis unit automatically sets a start time and an end time of an evaluation period of the variation in the power generation amount in a variation characteristic of the power generation amount with respect to a time to analyze the information about the form of the variation, including the reason for the variation in the power generation amount.

6. The power generation facility information management system according to claim 1, wherein the power generation variation information analysis unit analyzes the information about the form of the stop and the information about the form of the variation in the power generation amount, thereby calculating a total scheduled stop time, a total temporary stop time, a total controllable output variation value, and a total uncontrollable output variation value, and
the calculation unit acquires an environmental impact reduction planned value planned at a stage of design of the power generation facility and an environmental impact reduction actual value, acquires the total scheduled stop time, the total temporary stop time, the total controllable output variation value, and the total uncontrollable output variation value which have been calculated, and compares and analyzes the acquired results, thereby calculating factors that generate a difference between the environmental impact reduction planned value and the environmental impact reduction actual value.

7. The power generation facility information management system according to claim 6, wherein the calculation unit extracts an improvable factor of the factors that generate the difference between the environmental impact reduction planned value and the environmental impact reduction actual value, and calculates the reduction amount of the environmental impact when the improvable factor is assumed to be improved.

8. A power generation facility information management method comprising:
analyzing information about a form of a stop of power generation by a power generation facility, including a stop reason and a stop period of the power generation by the power generation facility, and information about a form of a variation in a power generation amount, including a reason for the variation in the power generation amount, thereby analyzing a possibility of reduction of an environmental impact caused by the power generation; and
calculating a reduction amount of the environmental impact when the stop in an avoidable power generation stop period is assumed to be avoided and calculating the reduction amount of the environmental impact when the avoidable variation is assumed to be avoided, based on an analysis result.
